(19) United States
(12) Patent Application Publication
(10) Pub. No.: US 2019/0108485 A1
(43) Pub. Date: Apr. 11, 2019

(54) METHODS FOR DELIVERY TO MULTIPLE LOCATIONS USING AUTONOMOUS VEHICLES

(71) Applicant: Blue Notepad, LLC, Wanhattan Beach, CA (US)

(72) Inventor: Thomas Danaher Harvey, Rockville, MD (US)

(21) Appl. No.: 16/130,902

(22) Filed: Sep. 13, 2018

Related U.S. Application Data
(63) Continuation of application No. 15/378,095, filed on Dec. 14, 2016, now abandoned.
Application No. 15/378,095 is a continuation of application No. 14/852,548, filed on Sep. 12, 2015, now abandoned.

(51) Int. Cl. G06Q 10/08

(52) U.S. Cl. CPC G06Q 10/08355; G06Q 50/30

(57) ABSTRACT

A method for parcel delivery includes transporting multiple parcels to a transfer location via a primary delivery vehicle; and then transporting at least some of the parcels from said transfer location to respective final delivery locations using a plurality of ground-based secondary delivery vehicles. At least two parcels are transported, at least partially simultaneously, by two distinct secondary delivery vehicles to two distinct delivery points. A final delivery location for each particular parcel is determined based on information associated with a corresponding delivery recipient of the parcel. The ground-based secondary delivery vehicles are each smaller than the primary delivery vehicle, are configured to access areas not accessible by the primary delivery vehicle.

### CROSS REFERENCE TO RELATED APPLICATIONS

This application is a continuation of U.S. patent application Ser. No. 15/378,095, filed Dec. 14, 2016, which is a continuation of U.S. patent application Ser. No. 14/852,548, filed Sep. 12, 2015, the entire contents of each of which are hereby fully incorporated herein by reference in their entirety for all purposes.

### STATEMENT REGARDING FEDERALLY SPONSORED RESEARCH OR DEVELOPMENT

Not Applicable.

### BACKGROUND OF THE INVENTION

### 1. Field of the Present Invention

The present invention relates to a method of delivering parcels to multiple locations using a road vehicle and autonomous final delivery vehicles.

### 2. Background Concerning the Need for the Current Invention

Billions of parcels are delivered to homes and businesses each year. For most of these parcels the stream coming from many sources is divided at depots and other central locations into batches to deliver to the final destination. A delivery vehicle departs with parcels and arrives at the nearest accessible point to the point of parcel acceptance and the final few yards of transport are accomplished manually.

The driver of the delivery vehicle can dismount and take the parcel to a door. Because in many cases the trip is to deliver only one parcel and the delivery process is suspended while this occurs, the driver's time must be minimized. It is common to see drivers running between their vehicles and the final delivery points. The cost is very high and there are adverse effects on quality. The doorbell is rung but no one waits to see if it's answered. If there is a problem such as an obsolete delivery address, there is no chance for correction. Parcels are left in the rain.

Advantages of the System of the Current Invention include having a separate vehicle to access the Final Delivery Point which can have different capabilities than the primary delivery vehicle, having Multiple Secondary Delivery Vehicles which can improve efficiency, and Late Acquisition of Delivery Access and Path Information which can be convenient or necessary for the recipient or the location controller (i.e. manager) of the final delivery area or final delivery point.

### BRIEF SUMMARY OF THE INVENTION

This application claims a method of delivering parcels to their final delivery points. This is accomplished by first getting information from a shipping party with a delivery address for the parcel. This address may only specify sufficient information to accomplish the first segment of the delivery process. The parcel is transported with a first vehicle which is adapted for and travels over the public roads to a transfer point. The parcel is then transferred to a second vehicle which is autonomous and which is adapted for and transports the parcel over the final space which is not accessible by vehicles using the public roads.

Additional information is acquired from the receiver of the parcel or the location controller of the space across which the parcel will be transported by the second vehicle. This information is used to determine the path for the second delivery segment. The parcel is then taken over that path to the final delivery location.

This method may also comprise additional elements. One of these is to have the additional information from the recipient or the delivery area manage be given to inform the second delivery segment after arrival at the first delivery point. Another element that may occur is to transport the second delivery vehicle with the parcel by means of the first vehicle, unload it at the transfer point and then accomplish the delivery. In another variation there is an enquiry to the recipient or the deliver area location controller after arrival of the parcel at the transfer point. The second stage information is acquired as a response to that inquiry. The enquiry may be made in response to arrival of the parcel at the transfer point or first location.

The information received for the second segment may also comprise a pass code or actually be embedded in a device to allow passage through checkpoints, locked doors or other restrictions to passage requiring authorization.

The second vehicle may be of limited size to pass the second delivery segment. This limitation may be in the form of being less than 32 inches in width to pass doorways sized to current US legal handicapped access requirements.

There may be a plurality of parcels which are carried by the first vehicle and are delivered by a plurality of second vehicles. The information from the receiver or the location controller is used to define a path for at least one of the vehicles.

The transportation over the public roads may be by other means if the means are informed by the address information on the particle.

### BRIEF DESCRIPTION OF THE SEVERAL VIEWS OF THE DRAWING

The features and advantages of the various embodiments disclosed herein will be better understood with respect to the drawing in which:

FIG. 1 is a plan view of a delivery area showing primary and secondary delivery vehicles, a transfer point, a final delivery point and other details.

FIG. 2 is a plan view of a delivery area showing primary delivery vehicle operated by the delivery service and secondary delivery vehicles operated by a location controller for delivery inside a multi-occupancy building.

FIG. 3 is a side view of a simple secondary delivery vehicle. Vehicle is adapted for sidewalks and short steps common to detached residential buildings. Shown are a parcel, a communication module, a processor and a sensor module.

FIG. 4 is a plan view of the secondary delivery vehicle of FIG. 3.

FIG. 5 is side view of the vehicle of FIG. 3 with the parcel-unloading device extended and the parcel being deposited on the ground.

FIG. 6 is a diagram of the information requirements for the first delivery segment and the final delivery segment.

FIG. 7 is a diagram of the delivery of multiple parcels.

### DETAILED DESCRIPTION OF THE INVENTION AND EMBODIMENTS

### Final Delivery Area and Final Delivery Point

The term final delivery area herein is used to refer to the area traversed after a parcel is transferred from a primary (herein also called first) to a secondary (herein also called second or final) delivery vehicle. The term final delivery point is the specific terminus of the second or final delivery segment where control of the parcel is surrendered to the parcel recipient, often by simply depositing the parcel. The distance traversed by the primary delivery vehicle is called the first delivery segment and ends in the transfer point.

### Description of Operations in a Simple Embodiment

A delivery service receives information from a shipping party which defines the location to which the parcel is to be delivered. This information can be on a label applied to the parcel by the shipping party but it can also be delivered separately in electronic, paper or other form. Here the contents of the information are referred to as the delivery address. The delivery address in combination with other information known to the delivery service at least defines an area where a transfer point can be established to accomplish the final delivery. It may or may not define the final delivery point.

The parcel is tendered to the delivery service which transports it to a location, here called a depot, from which it will be delivered to a final delivery point. In general, the depot will receive parcels from multiple shipping parties and consolidate deliveries which can be made from a common transfer point.

The parcel or multiple parcels are loaded onto a primary delivery vehicle which will transport the parcel in the first delivery segment. This phase of the delivery process is handled by the public road network or by a private road network which is equipped to handle vehicles of the types customarily used on public roads. The primary delivery vehicle may be autonomous or it may have a driver.

The first delivery segment ends when the primary delivery vehicle arrives at the transfer point. This is a location which is selected as being conveniently near to the final delivery point but accessible by the roads which can be used by the primary delivery vehicle. It must be a location from which the secondary delivery vehicle can reach the final delivery point, but the details of that access may not be available until the final delivery segment is underway.

The parcel is transferred to a secondary delivery vehicle. In some variations of this embodiment the secondary delivery vehicle may be carried along with the parcel by the primary delivery vehicle and released at the transfer point to complete the delivery. If the parcel is preloaded onto the secondary delivery vehicle then the transference is one of transferring the delivery process to the secondary delivery vehicle and unloading or releasing that vehicle. This is equivalent, in that case, to transferring the parcel itself to the secondary delivery vehicle.

In other variations of this embodiment or in other embodiments, the secondary delivery vehicle may be stationed at the transfer point or may come to the transfer point by some other means for vehicle delivery. The transfer point itself may be a form of depot where secondary delivery vehicles wait for parcels to be delivered. In many embodiments, there are multiple secondary delivery vehicles which handle multiple parcels from the same primary delivery vehicle which can thereby do its part of the delivery of multiple parcels in a single trip from the depot to the transfer point.

The second vehicle in this system, called the secondary delivery vehicle, is autonomous. This allows the driver of the primary delivery vehicle to be responsible for multiple simultaneous deliveries over the final delivery segment greatly increasing the throughput over a current system where a single delivery vehicle stops in the street and the driver dismounts and delivers the parcel by hand.

This secondary delivery vehicle is able to access final delivery points that are not accessible to the primary delivery vehicle or other vehicles adapted to use on the public roads. There are many reasons that a final delivery point may not be accessible to a larger vehicle. In many cases the paths and way between the transfer point and the final delivery location are not large enough to accommodate road vehicles. There may be features to traverse which can be crossed by appropriately designed smaller specialized vehicles but not road vehicles. Examples of these include stairs, handicap ramps, elevators and narrow doorways. The path to the final delivery point may have security restrictions which would prevent road vehicles or delivery personnel from being allowed access. The secondary delivery vehicles can be designed to overcome these problems. Secondary delivery vehicles may remain under the control of location controller between uses and so be able to accommodate security concerns.

Elements of the Current Inventive Concept

The various sections below describe elements of the invention herein disclosed and show their implementation in various embodiments. There are many other possible implementations and embodiments and the descriptions below should not be considered to limit embodiment to those described.

Delivery Address

When a parcel is tendered to a delivery service for delivery in the system here described the shipping party also transfers a delivery address to inform the delivery service about the desired destination for the parcel.

The delivery address must be sufficient in combination with other information that is available to the delivery service at least to identify the transfer point at which the parcel is transferred to the secondary delivery vehicle, but it does not necessarily identify the final delivery point or the delivery recipient. The acquisition of that information may be deferred until the secondary delivery vehicle takes the parcel. Thus, the information may not necessarily be made available to the delivery service for security or other reasons.

The method herein described typically starts with transferring a delivery address for a parcel to the delivery service. In some instances this is done in the traditional manner by putting a label on the parcel. In some embodiments the label designates the location to which the parcel is to be delivered. An example of this is the typical addressing of a letter in the United States postal system. The information tendered to the delivery service concerning a specific parcel is herein referred to as the delivery address.

The delivery address can omit information that can be accessed indirectly prior to delivery of the parcel to the final delivery point. One way that this is often done is to substitute a reference to the identity of a recipient for the address. An example would be “Deliver this to customer number 123,456.” In this case the delivery service would have access to a database which would provide at least information to move the parcel to the next stage of service. Another way, which can be used in combination, is to provide information which only allows determination of the transfer point where the responsibility for provision of information for delivery is assumed by another party. An example of this is to provide a delivery address which gives only the street address of the delivery. An example of this would be “1 Company Court; Sometown, N.Y.”

Additional information can be attached to the delivery address, especially in combinations of ways of limiting information. An example here would be “Department 123; c/o Receiving Department; 1 Company Court; Sometown, N.Y.”

Vehicles Operable on Public Roads

The primary delivery vehicle of this system operates on the public road system or on private roads and ways which are designed for such vehicles. The public road system is highly regulated in both the roads themselves and in the vehicles that are permitted to operate on them.

Restrictions on road vehicles include size minimums which are currently designed for human operated vehicles and intended to prevent use of toy vehicles on roads. As autonomous vehicles become common additional standards will be adopted for them and are likely to have much more detailed minimum size requirements. One reason for this is that vehicles likely not to be seen by other drivers would be considered dangerous.

The size and design of vehicles is also limited by requirements for lighting.

It is currently unknown the extent of usage of autonomous vehicles on public roads that will be allowed as the technology of such vehicles advances. Vehicles operated on public roads are required to have specific licenses from the various states before they may legally be driven on the roads.

Vehicles operated on public roads must have speed capabilities and performance to keep up with traffic.

Autonomous Vehicles

The vehicle which performs the final delivery segment is an autonomous or driverless vehicle. This means a vehicle which operates under the control of non-human processing equipment. It includes all vehicles other than those controlled by humans whether the human drive is on or with the vehicle or is operating the vehicle by a remote connection.

In some embodiments the autonomous vehicle may operate in an open loop manner from instructions or an internal map without changes from information delivered during the operation from sensors or other environmental information sources.

The autonomous vehicle may update the information in the movement plan or internal map by receiving information gathered by sources outside the vehicle or it may gather information from sensors associated with the vehicle. Regardless of the source of new information the updating of the plan or map may be continuous or in an incremental process.

Information which is supplied to the autonomous secondary delivery vehicle by the delivery recipient or the location controller is described below.

Autonomous vehicles have numerous advantages over human operated vehicles, especially over vehicles which carry humans. Among these is the smaller size, often much smaller. Avoidance of the need for safety measures to protect an operator although protective measures for other persons and property remain. The cost of a human operator is high. Even if a human is needed to dispatch, load or monitor vehicles, it is often the case that one person can handle a number of autonomous vehicles. It may be undesirable to have a human operator, even one working remotely, approach a final delivery point. This may be for safety, security or other reasons.

In some embodiments the autonomous vehicle may incorporate equipment to perform additional operations while delivering the parcel. For example, the parcel may be a specialized item which can be installed by the delivering equipment. An example of this would be in delivery of propane tanks with the vehicle doing an exchange of a new tank for an old one which is then removed.

Locations not Accessible by the Public Roads

Most final delivery points are not completely accessible by vehicles on the public roads. While a truck may back up to a dock or leave a heavy delivery parcel on the street after lowering it with a lift gate, a more common situation is to have the parcel delivered to the door.

There are numerous reasons that a final delivery point cannot be accessed by a public road vehicle. For example there may be narrow paths which are not designed to allow larger vehicles. There may be non-vehicle doors to be passed. There may be stairs to be climbed. Safety requirements may prevent driving road vehicles in certain areas. The final delivery point may be inside a building and accessible by an elevator. All of these situations occur in the various embodiments of the current described invention.

The inaccessibility of the final delivery point may be physical in nature as in the narrow paths, stairs or elevators above. In other cases the inaccessibility may be imposed administratively for non-physical reasons such as security, safety or even to maintain decorum.

Administrative inaccessibility can also come from the need to perform operations or deliver services other that the actual parcel delivery in conjunction with the delivery. Examples include security inspections which may be impractical with road vehicles, delays which would hold up a primary delivery vehicle from making other deliveries, handling restrictions depending on the nature of the parcel which may be large or require special handling and many other special situations.

Transfer Point

At the transfer point the parcel is loaded onto the secondary delivery vehicle. That vehicle then begins to undertake the movement of the parcel across the final delivery segment.

The transfer point may be under the control of the delivery service, the location controller or the delivery recipient.

The parcel may wait at the transfer point for availability of a secondary delivery vehicle or for the completion of auxiliary processes.

Location Controller

The secondary delivery vehicle performs the delivery, thereby executing the final delivery segment. The final delivery segment may at least partially be in an area under control of the delivery recipient or a third party, such as a building manager or the management of a campus, military base or other group of buildings. That party is referred to as a location controller in this specification and in the claims.

If there is a location controller, that party has control of a portion of the final delivery segment, either with respect to that process or with respect to the location, equipment or environment there.

A typical location controller comprises staff associated with the management of a building where deliveries through a common transfer point are made to multiple final delivery points controlled by different tenants or operations in the building. A location controller can provide physical facilities such as an elevator to access different floors and information for delivery processes as described below.

Delivery Recipient

A delivery recipient is the party with control of the final delivery location. The delivery recipient is not necessarily the beneficial recipient of the parcel. For example, a parcel addressed in care of a person may be delivered to that person as the delivery recipient. Further delivery processes not a part of the herein described methods may then take place in getting the parcel to the beneficial recipient.

A delivery recipient is not necessarily present when the parcel arrives at the final delivery point. But in many cases provides information about the final delivery point and about the desired delivery methods, routes or other delivery aspects.

Required Information for Final Delivery Segment

The required information for the first delivery segment is generally not sufficient to accomplish the final delivery segment. That information is collected from the delivery address, from the resources of the delivery service and from third parties. It allows the first delivery segment to proceed, but in the system herein disclosed additional information much be gathered from the delivery recipient or the location controller.

Information from either or both of the delivery recipient or the location controller may be called final segment source information.

A distinction may be made between final source information which is provided prior to the arrival of the first vehicle at the transfer point and information acquired during the accomplishment of the final delivery segment.

Information from Delivery Recipient or Location Controller

Prior to the completion of the first delivery segment, final source information may be delivered through systems operated by the delivery service, associated with the first vehicle, operated by third parties or in other ways. The information is final source information because of its source. It may be delivered in advance to be used for current or future as yet unscheduled deliveries or it may be specific information applying to a specific delivery. It may be the result of an interrogation from the delivery service about deliveries in general or about a specific parcel to be delivered.

On arrival of the first vehicle at the transfer point additional final source information may be acquired to us in the final deliver process. This may come from a one-way or interactive communication system set up to inform deliveries or may be provided by signs, markers or other devices to be read by sensors associated with the second vehicle.

A very basic device for delivering final source information is a human readable sign, e.g. “Deliveries in the Rear Only” Such a sign can be read by video cameras with suitable processing and also by other delivery systems such a human delivery personnel.

A communication method more directly adapted to the disclosed system is optically readable barcode signs with specific information. Two dimensional barcode systems are easily handled by video readers and can handle a large amount of information. They can deliver not only high level information as the human readable signs, but also more complicated instructions such as a multi-step program of precisely defined movements which vary on the basis of many type of conditional factors. The conditional factors include times, type of parcels and deliveries, shipping party and delivery service information, instructions for inquiries to be made, references to other information sources and many other factors.

The information from delivery recipients or location controllers includes information from signs, markers, etc. provided specifically to inform this parcel delivery or parcel deliveries in general.

This information can be delivered by local electronic links or by more wide area communication networks. There is no dependence on the communication means but this information is defined by the time, intended usage and the identity of the parties make it available.

In some embodiments there may be an interrogation of the recipient or the location controller to get needed information. This interrogation can be made by any party and replies can form the information input from the recipient or location controller.

Path Defining Information

The secondary delivery vehicle must operate over a path sufficiently defined to allow autonomous operation from the transfer point to the final delivery point. Part of the information to define that path may already be known to the shipping service or stored in the controlling devices for the secondary delivery vehicle. Another part of the information may be available from public or at least widely available sources. But, critical parts of the information often come from the parties controlling the final delivery segment or the final delivery point.

The path defining information is used in combination with other information to compute a path for the autonomous vehicle. This can be done by a processor on the secondary delivery vehicle but can also be done by a central server or a third party controlled process. The computed path can be calculated at the beginning of the traverse of the secondary delivery segment and followed thereafter or can be updated during the movement of the secondary delivery vehicle.

Authorization to Pass Restriction

In addition to having to navigate across the final delivery segment the secondary delivery vehicle will often have to pass various barriers to reach the final delivery point. Most of these will represent a form of security such as checkpoints, locked gates, locked doors or other forms of intentional denial of passage. Some barriers will be for other purposes and may take forms such as calling for elevators, lowering drawbridges, coordinating with other traffic or other practical or physical requirements.

The delivery recipient and the location controller can transfer information that allows the secondary delivery vehicle to pass the restriction. This information can be provided by electronic means, postings to be read by the vehicle which may be encrypted or embedded in a physical token which is given to or attached to the vehicle while executing the final delivery segment.

The information to pass restrictions may be in a very limited security form such as a printing with infrared ink on a posted sign which can be read by the machine to transfer a very low security passcode. Or it may take a much higher security form such as an encrypted passcode which can only be decrypted by the secondary delivery vehicle and is only good for the one visit.

Operational Control of Location Controller or Delivery Recipient

The area containing the final delivery segment is called the final delivery area and in many applications of the concept herein described is under the control of a party other than the parcel recipient, shipping party or delivery service. This party is called the location controller. The location controller in these cases provides the final delivery information to be used by the secondary delivery vehicle. The location controller often operates an information delivery system for that purpose. It may comprise signs and markers with information, an electronic information delivery and communication system or a data acceptance and entry system to get information from parcel recipients.

### Detailed Description of the Drawing and Certain Embodiments

### First Description of an Embodiment in the Figures

This embodiment as described in this section with a delivery van as commonly used by delivery services, a driver to handle exceptions and final delivery information delivered by two dimensional barcodes read by a video sensor on the autonomous secondary delivery vehicle is the current preferred embodiment.

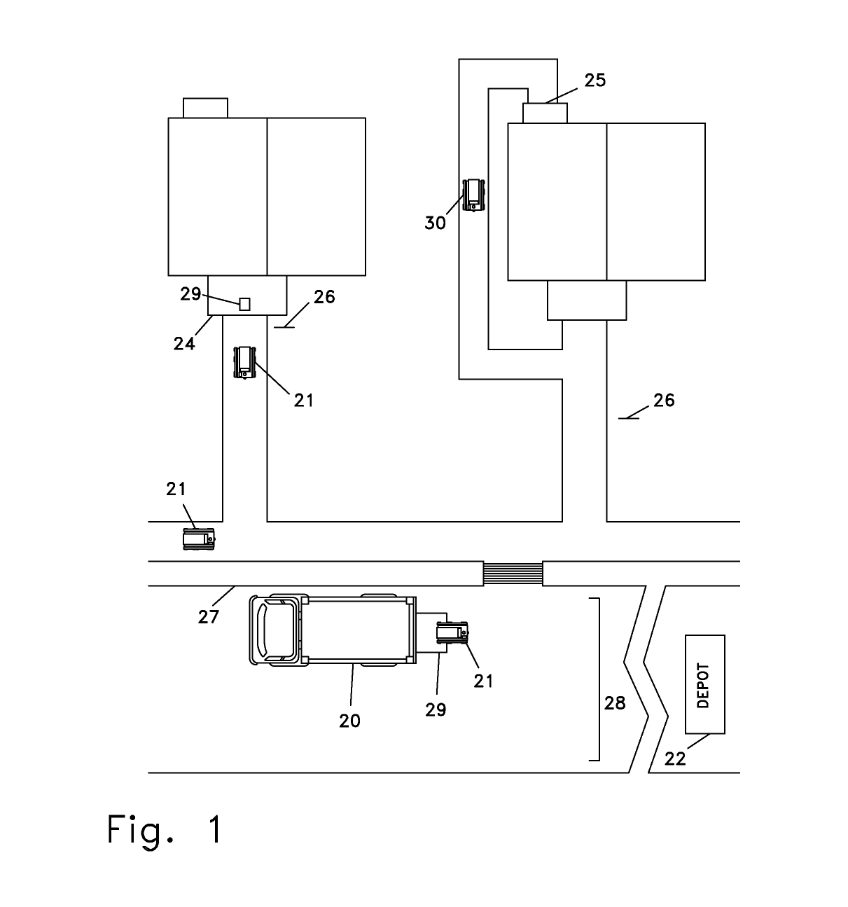

Referring to FIG. 1, a primary delivery vehicle 20 has left a depot 22 with a cargo of secondary delivery vehicles 21 and parcels to be delivered. It has traveled on public roads stopping at the curb 27 of a public road 28 to create a transfer point 29 by lowering a ramp to launch secondary vehicles 21 bearing parcels.

In the specific version of the embodiment pictured in the figure, the final delivery points are located at various locations associated with detached houses called out by the delivery addresses. In some embodiments the primary delivery vehicle is autonomous and carries no human personnel, in other cases there is a human driver for the primary delivery vehicle who operates that vehicle and may have other duties such as loading parcels onto secondary delivery vehicles or handling exceptions to normal deliveries. The secondary delivery vehicles are autonomous.

One secondary delivery vehicle bears a parcel for the first final delivery point 24. On the basis of information from the delivery address sent with the parcel by its sender; that vehicle starts down the front walk of the designated house and detects an information sign 26 concerning deliveries with a sensor, in the particular version of the embodiment pictured that sensor could be a video camera with an appropriately programmed processor to read two dimensional barcodes and the sign could be a two dimensional barcode. In one appropriate version the barcode could read “Leave deliveries on step and email eager_recipient@server.com. As depicted, the vehicle has unloaded the parcel 29 and is leaving to return to the transfer point.

Another secondary delivery vehicle 30 bears a parcel for another house associated with another final delivery point 25. The vehicle reads with its sensors a sign 26 with a different message such as “deliver parcel number xxxx to rear door accessed by sidewalk on left.” That secondary delivery vehicle is shown heading down the walkway to the rear door 25. Two additional secondary delivery vehicles are shown one coming off the ramp at the rear of the primary delivery vehicle 20 after receiving a parcel.

The secondary delivery vehicles in this description are carried by the primary or first delivery vehicle, unloaded and made available for the final segment of the delivery. The parcels may be loaded on the secondary delivery vehicles at the transfer point or they may be preloaded on the secondary delivery vehicles, in which case the transfer point and beginning of the final delivery segment is the point where the secondary delivery vehicles are unloaded from the first vehicle.

### Second Description of an Embodiment in the Figures

This and related embodiments involve a delivery truck meeting a fleet of autonomous delivery vehicle stored at the entrance of a complex of final delivery points. The autonomous vehicles are operated by the location controller.

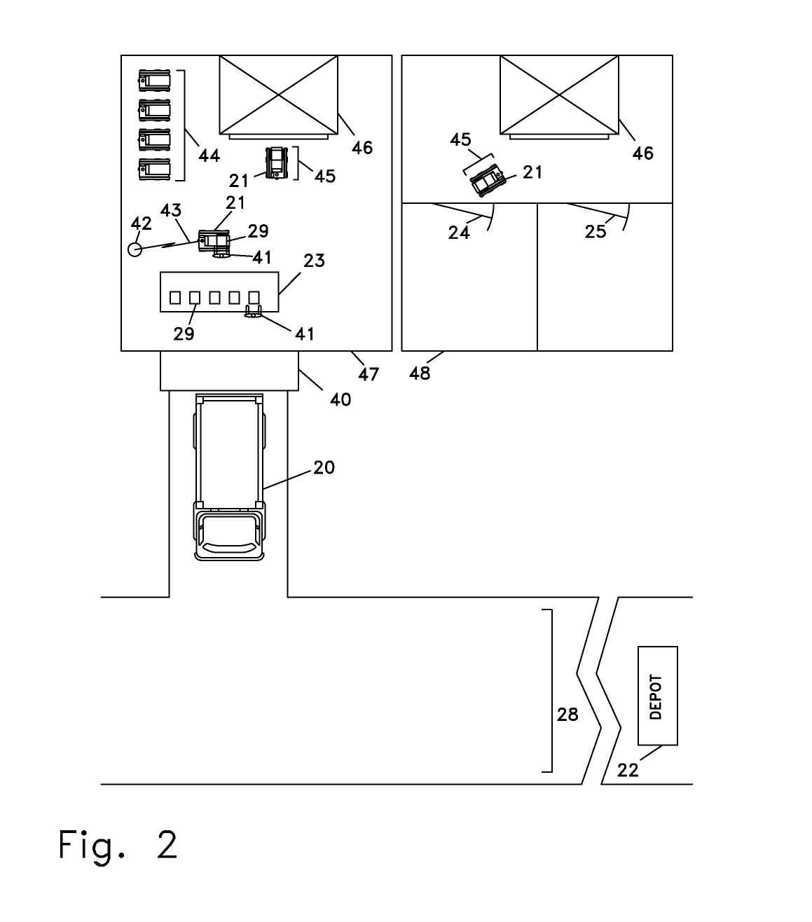

Referring to FIG. 2, a primary delivery vehicle 20 has left a depot 22 with a cargo of parcels to be delivered. It has traveled on public roads stopping at a loading dock 40 accessible from a public road 28 to deliver parcels to a transfer point 23 for further loading onto secondary delivery vehicles 21.

The pictured version of this embodiment envisions delivery to a multi-occupant building such as an office building or an apartment house. Only a few final delivery points are pictured but in actual situations may such point and many delivery recipients may exist. In the pictured version of this embodiment the secondary delivery vehicles are operated by the management of the building which receives the parcels from the delivery service and handles the final delivery segment.

The parcels 29 are taken from the primary delivery vehicle, in this case by building personnel 41 and placed on a table which here has the role of a transfer point 23. One or more parcels are loaded on a secondary delivery vehicle for delivery to final delivery points. A supply of secondary delivery vehicles is ready 44. A communication device 42 sends final delivery information to the secondary delivery vehicle with a signal 43.

The final delivery information in one specific version of the embodiment comes from a computerized system to receive instructions from parcel recipients. The recipient enters information about times to deliver parcels to the recipients and times to hold incoming parcels for later acceptance. This provides a measure of security because only the location controller knows the times the recipient will be home. The location controller then bases the instructions to the secondary delivery vehicles on the time stored in its database.

The parcel to be delivered on its secondary delivery vehicle 45 is shown ready on the operational floor of the building 47 to enter an elevator to approach the final delivery point or points on one of the occupancy floor of the building. On arrival at the floor designated by the final delivery information the secondary delivery vehicle proceeds to the final delivery point and makes the delivery. Another final delivery point for a different parcel which in this case will come with a different secondary delivery vehicle stands ready 25.

### Description of a Secondary Delivery Vehicle in Certain Embodiments

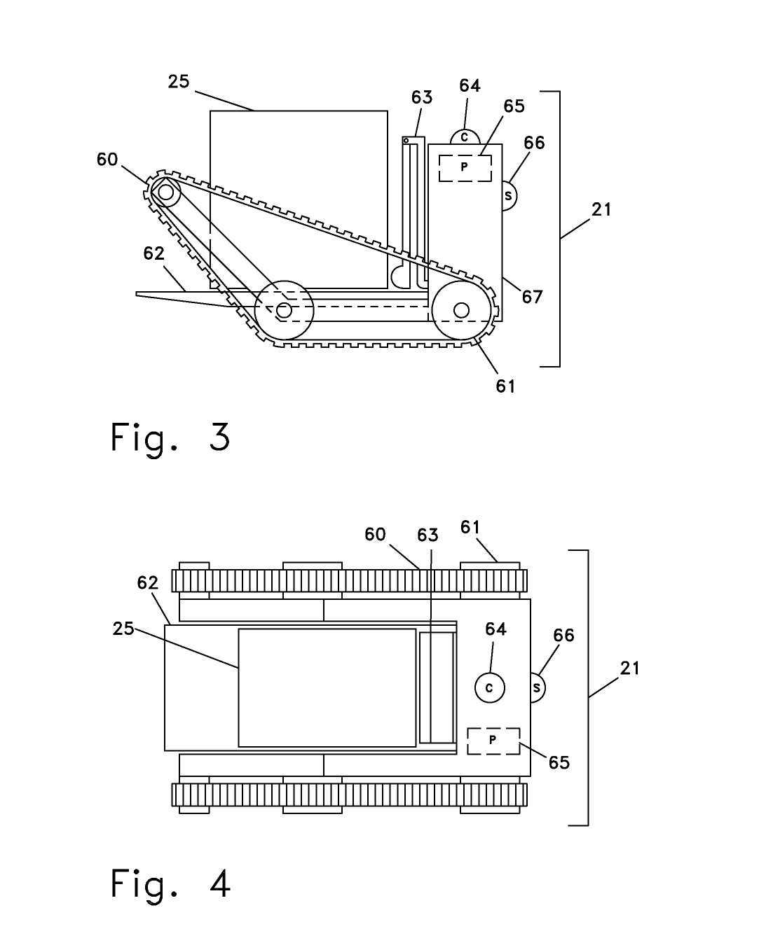

Referring to FIG. 3 a secondary delivery vehicle 21 of certain embodiments is shown in a left side view. It carries a parcel 25. A pair of tractor belts 60 is adapted to allow it to travel over moderately difficult obstacles such as the low steps that are often found in the walkways of residential premises. The belts are driven by drive wheels 61 on each side of the vehicles. Differential rotation of the drive wheels allows steering. The parcel 25 is held on a platform and a load kicker 63 is provided to unload the parcel. The drive wheels, load kicker, platform and other moving components are operated by motors and power supply components located in the operational unit 67. A communications module 64 communicates with the delivery service, the location controller, the delivery recipient and third-party information services as needed to navigate and exchange information as needed for the implementation of the concept of this disclosure as to perform the final segment of the delivery. In some variations of the embodiments a processor 65 stores the navigation and other information and operates the vehicle. In other variations the processor or other electronics 65 functions to implement low level commands which are processed by computers not a part of this vehicle and relayed by a communication link to the communications module.

There is a sensor module 66 which in various versions carries sensors to gather information. The sensors can be designed to detect the physical environment and implement the autonomous functions of the vehicle. This would allow a vehicle to avoid obstacles, move toward the final delivery point and provides safe operational methods to avoid injury or damage to persons or property.

The sensor module can also receive information that is supplied specifically to facilitate deliveries by the delivery recipient or the location controller. One form these could take is posted signs or devices such as two-dimensional barcodes to indicate the preferred paths or behaviors of the vehicle. Another form would be markers which could be sensed by the sensor module to direct the motions of the vehicle. They could be point markers such as reflective targets or extended markers such as a radio frequency cable buried beneath a walkway.

The sensor module could also receive active communications which represent directions for the path to be taken or coded keys to pass restrictions. For example, an infrared beacon could flash an encoded message when deliveries are expected, e.g. “food deliveries to rear door, others to front.”

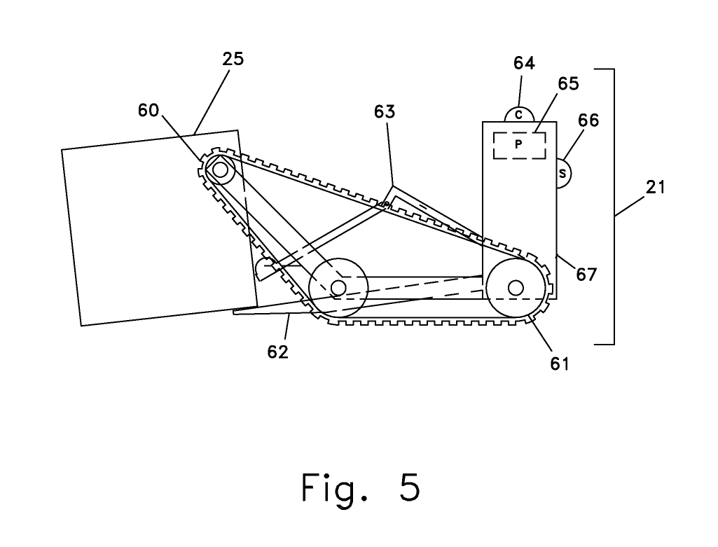

Referring to FIG. 4, a top view of the secondary delivery vehicle 21 of FIG. 3 is shown. Referring to FIG. 5, the secondary delivery vehicle 21 of FIG. 3 is shown with the load kicker 63 extended to unload the parcel on the ground in front of the vehicle. The load platform 62 is shown lowered to facilitate the unloading.

For most applications, the secondary delivery vehicle should be made small enough to pass through common doorways and other openings. Current ADA standards require that door openings be at least 36 inches wide and have a clear opening width allowing for interference from a swinging door of at least 32 inches. Therefore, a vehicle less than 32 inches wide can pass into ADA compliant passages. Because some opens are not so compliant an even narrower vehicle is generally preferable.

Information Requirements Described in a Figure

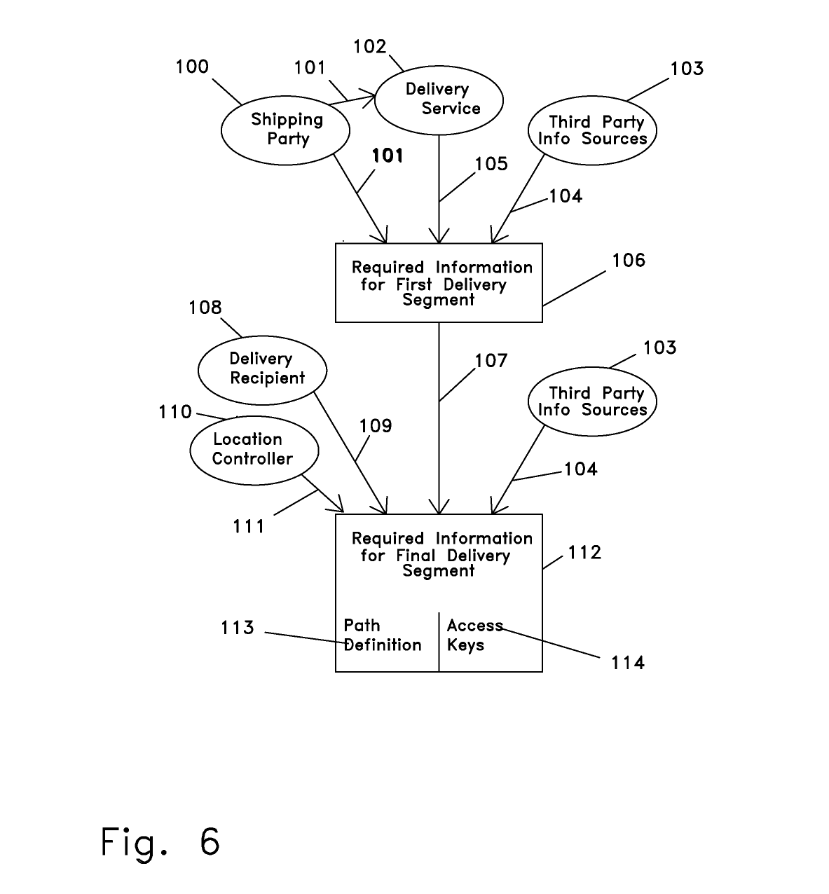

Referring to FIG. 6, the information requirements for the first delivery segment and for the final delivery segment are diagramed. Because information can be held, transferred and used in many ways the examples given are necessarily incomplete and should not be viewed as limiting. They are provided to give understanding of the type, content, form, source and use of the particular information addressed.

A shipping party 100 tenders a parcel to the shipping service. Information 101, referred to as a shipping address, that defines directly or indirectly at least a terminus for the first delivery segment for the parcel is also transferred to the shipping service. This information in some cases is limited to identifying a transfer point where the responsibility for further directing the delivery is taken over by a location controller for the transfer point, a delivery recipient or a party representing management of downstream locations. In other cases information can be included that defines part of the path of the final delivery segment, part of the access information to pass along that path or part of the final delivery point location or address. This information would be supplemented as described below to complete the information needed for the final delivery segment.

The delivery service 102 transfers 105 necessary delivery address information as well as other information known the delivery service to the data to be used to manage the first delivery segment 106. Additional information 104 can be added from third party sources 103. The required information to guide the first delivery segment may be held in a variety of places, it may be provided to a database associated with or carried with the first delivery vehicle. To list only a few of the many ways that this information may be used in various cases and embodiments, where the first delivery vehicle has a driver the information may be an address on a clipboard carried by the driver or the driver may have a display showing that information in the vehicle, where the first delivery vehicle is autonomous the information may be held in a data store of that vehicle or it may be delivered as needed from a central data store over a communication link.

At the transfer point (for example 29 of FIG. 1) a portion of the first delivery segment information 106 may be transferred 107 into the final delivery segment information 112. Additional information may again be transferred 104 from third party sources 103.

Additional information is here added from local sources. The local sources include the location controller 110 transferring 111 by many possible means and the delivery recipient 108 transferring 109 again by many possible means.

Sorting and Handling of Multiple Parcels

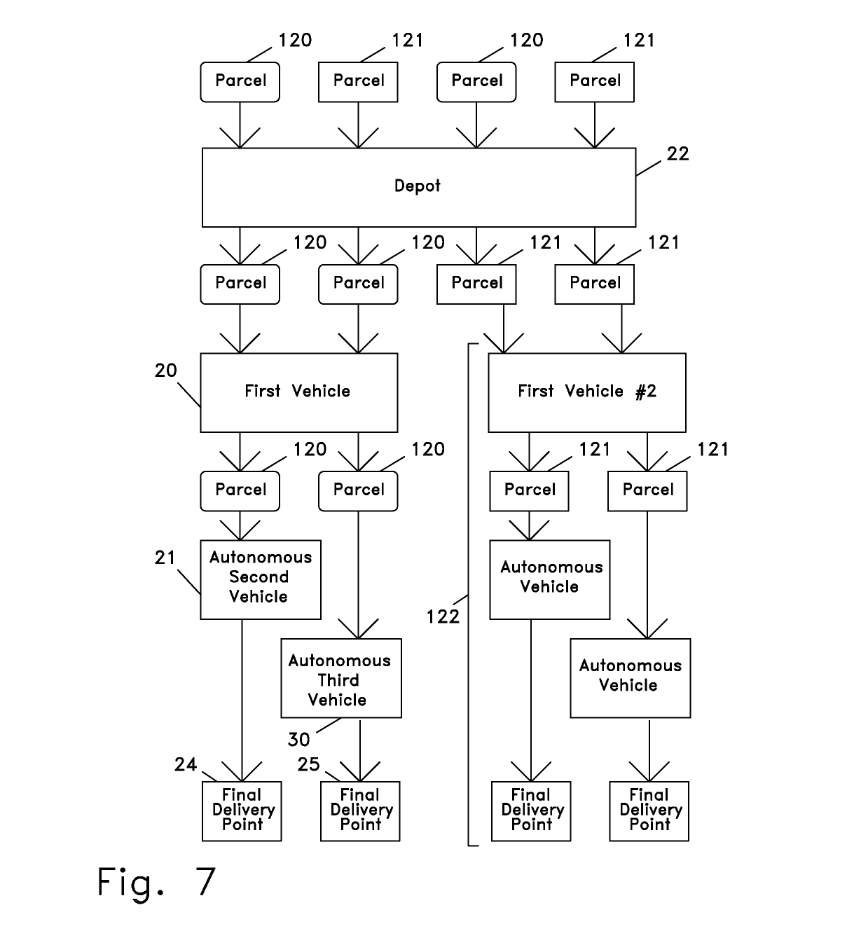

Referring to FIG. 7, a diagram of the handling of Parcels in a situation where presorting of parcels allows multiple parcels to be transported and handled. Two parcels 120 for delivery in a limited area are shown they are distinguished in the figure by rounded corners. An additional two parcels 121 are for another area. The parcels are transferred by their shipping parties to a central depot 22 run by a delivery service and sorted by their destination areas. The parcels 120 are determined to be in area can be accessed from a common transfer point 29 (see also FIG. 1 to follow the parcels) and are placed in the same first vehicle 20. At the transfer point 23 the parcels are placed in two separate autonomous secondary delivery vehicles 21, 30 and are delivered to separate final delivery points 24, 25. Another set of parcels for delivery in another limited area is shown as 122. They will be delivered with another first vehicle, pair of secondary delivery vehicles and a different transfer point.

I claim:

1. A method for parcel delivery, the method comprising:
(A) transporting multiple parcels to a transfer location via a primary delivery vehicle; and then
(B) transporting at least some of the parcels from said transfer location to respective final delivery locations using a plurality of ground-based secondary delivery vehicles,
wherein, in (B), at least two parcels are transported, at least partially simultaneously, by two distinct secondary delivery vehicles to two distinct delivery points, and
wherein a final delivery location for each particular parcel transported in (B) is determined based on information associated with a corresponding delivery recipient of said particular parcel, and
wherein the secondary delivery vehicles are each smaller than the primary delivery vehicle, and
wherein the secondary delivery vehicles are configured to access areas not accessible by the primary delivery vehicle.

2. The method according to claim 1, further comprising:
(C) the primary delivery vehicle waiting at said transfer location after transferring said multiple parcels to said location.

3. The method of claim 1, wherein at least some of said plurality of ground-based secondary delivery vehicles are also transported to said transfer location using said primary delivery vehicle.

4. The method of claim 1, wherein said plurality of ground-based secondary delivery vehicles comprise a first delivery vehicle and a second delivery vehicle, and wherein,
in (B),
(B)(1) said first delivery vehicle transports at least a first parcel to a first final delivery location, and
(B)(2) said second delivery vehicle transports at least a second parcel to a second final delivery location,
wherein at least some of said transporting in (B)(1) occurs during at least some of the transporting in (B)(2).

5. The method of claim 1, further comprising:
transferring at least some of the multiple parcels to at least some of said ground-based plurality of secondary delivery vehicles.

6. The method of claim 5, wherein at least some of said transferring occurs at said transfer location.

7. The method of claim 5, wherein at least some of said transferring occurs prior to said primary delivery vehicle reaching said transfer location.

8. The method of claim 6, wherein at least some of the transferring occurs in response to one or more delivery requests.

9. The method of claim 1, wherein information about at least one final delivery location for at least one parcel is acquired subsequent to the primary delivery vehicle's arrival at the transfer location.

10. The method according to claim 1, wherein particular information about a particular final delivery location for a particular parcel is provided to a particular ground-based secondary delivery vehicle carrying said particular parcel by a location controller and/or the delivery recipient.

11. The method according to claim 1, wherein, for at least one particular parcel, the information associated with the corresponding delivery recipient of said at least one particular parcel includes at least: (i) a final delivery location for said at least one particular parcel; and/or (ii) instructions for arriving at said final delivery location, and/or (iii) a time interval for delivery of said at least one particular parcel to said final delivery location.

12. The method according to claim 11, wherein at least some of the information associated with the corresponding delivery recipient of said at least one particular parcel was received in a delivery request for said at least one particular parcel.

13. The method according claim 11, further comprising:
(C) for at least one particular parcel having a corresponding particular final delivery location associated therewith, computing a path to said particular final delivery location, said path being based, at least in part, on information associated with the corresponding delivery recipient of said at least one particular parcel.

14. The method according claim 13,
wherein the information comprises instructions for arriving at said final delivery location, and wherein the path is computed in (C) at least partially based on the instructions.

15. The method according claim 13,
wherein the information comprises a time interval for delivery of said particular parcel to said particular final delivery location, and wherein the path is computed in (C) at least partially based on the time interval.

16. The method of claim 15, wherein at least one ground-based secondary vehicle waits at the transfer location before transporting the particular parcel to the particular final delivery location.

17. The method of claim 15, wherein a secondary vehicle carrying said particular parcel departs the transfer location at such a time so as to arrive to the final delivery location within the time interval for delivery of said particular parcel.

18. The method according claim 1, further comprising, while transporting a parcel to a final delivery location in (B), said secondary delivery vehicle receiving information gathered by sources outside said secondary delivery vehicle, and updating an internal map base on said information.

19. The method according to claim 1, further comprising:
at least one ground-based secondary delivery vehicle installing contents of the parcel at a corresponding final delivery location.

20. The method according to claim 1, wherein, for at least one parcel transported in (B), the recipient and/or final destination is/are not known before said at least one parcel reaches said transfer location.

21. The method according to claim 1, wherein, for at least one parcel transported in (B), the recipient and/or final destination is/are known before said at least one parcel reaches said transfer location.

22. The method according to claim 21, wherein said multiple parcels are transported in (A) from a depot to said transfer location, and wherein, for at least one parcel transported in (B), the recipient and/or final destination is/are determined after said depot and before said at least one parcel reaches said transfer location.

23. The method of claim 21, wherein said multiple parcels are transported in (A) from a depot to said transfer location, and wherein, for at least one parcel transported in (B), the recipient and/or final destination is/are determined after leaving said depot and before said at least one parcel reaches said transfer location.

24. The method of claim 1, wherein, for at least one particular parcel being delivered by a particular ground-based secondary delivery vehicle to a particular final delivery location, access to said particular final delivery location requires authorization, and wherein said particular ground-based secondary delivery vehicle obtains said authorization.

25. The method of claim 24, wherein said authorization comprises authorization to traverse a barrier on a path between said transfer location and said particular final delivery location.

26. The method according claim 24, where said authorization is obtained from at least one of a location controller and/or the delivery recipient prior to said particular ground-based secondary delivery vehicle departing the transfer point.

27. The method according to claim 24, wherein the at least one particular parcel remains at the transfer point until authorization to access the particular final delivery location is received.

28. The method according to claim 1, further comprising:
(C) at least some of said plurality of ground-based secondary delivery vehicles returning to said transfer location after making their corresponding deliveries.
